(19) United States
(12) Patent Application Publication
(10) Pub. No.: US 2006/0210804 A1
(43) Pub. Date: Sep. 21, 2006

(54) Resin composition, foamed molding and laminate

(75) Inventors: Katsuhiro Yamada, Ichihara-shi (JP); Tatsuhiro Nagamatsu, Chiba-shi (JP)

Correspondence Address: FITCH, EVEN, TABIN & FLANNERY, P. O. BOX 65973, WASHINGTON, DC, 20035, US

(73) Assignee: Sumitomo Chemical Company, Limited, Tokyo (JP)

(21) Appl. No.: 11/354,895

(22) Filed: Feb. 16, 2006

(30) Foreign Application Priority Data
Oct. 28, 2004 (JP) 2004-313535
Oct. 28, 2004 (JP) 2004-313536
Mar. 8, 2005 (JP) 2005-063453
Oct. 27, 2005 (JP) 2005-312425
Oct. 27, 2005 (JP) 312426

(51) Int. Cl. C08L 23/04; B32B 9/04

(52) U.S. Cl. 428/411.1; 525/240

(57) ABSTRACT

A resin composition wherein the content of the following component (i) is 99 to 30 wt % and the content of the following component (ii) is 1 to 70 wt %, a pressurized foaming molded body of the resin composition, and a laminate obtained by laminating a layer composed of the pressure-foamed molding and a layer composed of another material: (i) an ethylene-a-olefin-based copolymer comprising an ethylene monomer unit and an a-olefin monomer unit having 3 to 20 carbon atoms wherein the melt flow rate is 0.01 to 5 g/10 minutes and the activation energy for flow is 30 kJ/mol or more, (ii) an ethylene-unsaturated ester-based copolymer comprising an unsaturated ester monomer unit and an ethylene monomer unit.

### BACKGROUND ART

1. Field of the Invention

The present invention relates to a resin composition, its pressure-foamed molding and a laminate having a layer of the foamed molding.

2. Description of Related Art

A foamed molding composed of a polyethylene-based resin and a laminate obtained by laminating this and a molding composed of a non-polyethylene-based resin are widely used as miscellaneous daily goods, floor materials, sound insulators and heat insulators, and there are known, for example, a sole obtained by laminating an upper bottom produced by pressure-foaming an ethylene-vinyl acetate copolymer to obtain a molding, cutting this into desired shape to give a member and pressure-foaming the member again, and a lower bottom composed of styrene-butadiene rubber or the like (see, e.g. JP 11-151101A), and the like.

However, the above-mentioned foamed molding was not sufficiently satisfactory in balance between lightness and rigidity, further, a laminate obtained by laminating this and a molding composed a non-polyethylene-based resin, was also not necessarily satisfactory.

### SUMMARY OF THE INVENTION

Under such situations, an object of the present invention is to provide a resin composition which gives a pressure-foamed molding excellent in balance between lightness and rigidity, the pressure-foamed molding, and a laminate obtained by laminating a layer of the pressure-foamed molding and a layer composed of a material different from the foamed layer.

Further, another object is to provide a resin composition which gives a pressure-foamed molding having a high strength in addition to the above-mentioned matter, the foamed molding, and a laminate excellent in interlaminar adhesion containing a layer of the pressure-foamed molding.

That is, the present invention relates to a resin composition comprising the following components (i) and (ii) wherein the content of the component (i) is 99 to 30 wt % and the content of the component (ii) is 1 to 70 wt % based on the total amount of the components (i) and (ii) of 100 wt %:

(i) an ethylene-a-olefin-based copolymer comprising a monomer unit based on ethylene and a monomer unit based on an a-olefin having 3 to 20 carbon atoms, wherein a melt flow rate is 0.01 to 5 g/10 minutes and an activation energy of flow is 30 kJ/mol or more,

(ii) an ethylene-unsaturated ester-based copolymer comprising a monomer unit based on at least one unsaturated ester selected from vinyl esters of carboxylic acids and alkyl esters of unsaturated carboxylic acids and a monomer unit based on ethylene.

Further, the present invention relates to a pressure-foamed molding obtained by pressurized-foaming the above-mentioned resin composition.

Still further, the present invention relates to a laminate obtained by laminating a layer composed of the above-mentioned pressure-foamed molding and a layer composed of a non-ethylene-based resin material.

The present invention can provide a resin composition which gives a pressure-foamed molding excellent in balance between lightness and rigidity, the pressure-foamed molding, and a laminate containing a foamed layer of the pressure-foamed molding. Further, the present invention can provide a resin composition which gives a pressure-foamed molding further excellent in strength, the pressure-foamed molding, and a laminate containing it.

### DETAILED DESCRIPTION OF INVENTION

The ethylene-a-olefin-based copolymer as the component (i) is an ethylene-based copolymer containing a monomer unit based on ethylene and a monomer unit based on an a-olefin having 3 to 20 carbon atoms (hereinafter, referred to simply as a-olefin). The a-olefin includes propylene, 1-butene, 4-methyl-1-pentene, 1-hexene, 1-octene, 1-decene and the like. Preferable are 1-butene and 1-hexene.

The ethylene-a-olefin-based copolymer as the component (i) includes an ethylene-1-butene copolymer, ethylene-4-methyl-1-pentene copolymer, ethylene-1-hexene copolymer, ethylene-1-octene copolymer, ethylene-1-decene copolymer, ethylene-1-butene-4-methyl-1-pentene copolymer, ethylene-1-butene-1-hexene copolymer, ethylene-1-butene-1-octene copolymer and the like, and from the view point of strength, preferable are an ethylene-1-butene copolymer, ethylene-1-hexene copolymer and ethylene-1-butene-1-hexene copolymer, and more preferable are an ethylene-1-butene-1-hexene copolymer and ethylene-1-hexene copolymer.

The ethylene-a-olefin-based copolymer as the component (i) preferably contains a monomer unit based on ethylene in an amount of 50 wt % or more based on the total monomer unit content in the copolymer of 100 wt %. When the ethylene content increases, a density of the copolymer becomes higher, therefore, it is preferable to make a control so that the density is 930 kg/m³ or less as mentioned after.

The ethylene-a-olefin-based copolymer as the component (i) has a melt flow rate (MFR) of 0.01 to 5 g/10 minutes. When the MFR is less than 0.01 g/10 minutes, foaming magnification lowers in some cases, and the MFR is preferably 0.05 g/10 minutes or more, more preferably 0.1 g/10 minutes or more. In addition, when the MFR is over 5 g/10 minutes, the interlaminar adhesion of a multi-layered molded body lowers in some cases, and the MFR is preferably 2 g/10 minutes or less, more preferably 0.8 g/10 minutes or less, further preferably 0.6 g/10 minutes or less. The MFR is measured by an A method under conditions of a temperature of 190° C. and a load of 21.18 N according to JIS K7210-1995.

The ethylene-a-olefin-based copolymer as the component (i) is a copolymer having an activation energy of flow (Ea) of 30 kJ/mol or more. When Ea is too low, bubble condition becomes non-uniform to deteriorate appearance in some cases. From the standpoint of enhancement of bubble condition, Ea is preferably 40 kJ/mol or more, more preferably 50 kJ/mol or more, further preferably 55 kJ/mol or more. From the standpoint of more smooth surface of a pressure-foamed molding, Ea is preferably 100 kJ/mol or less, more preferably 90 kJ/mol or less.

The activation energy of flow (Ea) is a numerical value calculated according to an Arrhenius type equation from a shift factor (a_{T}) in making a master curve showing dependency of melt complex viscosity (unit: Pa·sec) at 190° C. on angular frequency (unit: rad/sec) based on a temperature-time superposition theory, and obtained by the following method. Namely, melt complex viscosity-angular frequency curves (unit of melt complex viscosity is Pa·sec, and unit of angular frequency is rad/sec) of an ethylene-a-olefin copolymer at respective temperatures of 130° C., 15° C., 170° C. and 190° C. (T, unit: ° C.) are superposed on a melt complex viscosity-angular frequency curve of an ethylene-based copolymer at 190° C. for every melt complex viscosity-angular frequency curve at each temperature (T) based on a temperature-time superposition theory, and a shift factor (a_{T}) at each temperature (T) obtained in the superposition is measured, and a primary approximation of [ln(a_{T})] and [l/(T+273.16)] is calculated (the following formula (I)) according to a least square method from respective temperatures (T) and a shift factor (aT) at each temperature (T). Next, Ea is obtained from inclination m of the primary equation and the following formula (II).
ln(a_{T})=m(l/(T+273.16))+n (I)
Ea=|0.008314×m (II)
a_{T}: shift factor
Ea: activation energy of flow (unit: kJ/mol)
T: temperature (unit: ° C.)

The above-mentioned calculation may use a commercially available calculation software, and this calculation software includes Rhios V.4.4.4 of Rheometrics, and the like. The shift factor (a_{T}) is a shift amount when log-log curves of melt complex viscosity-angular frequency at respective temperatures (T) are allowed to shift along log(Y)=−log(X) axis direction (wherein, Y axis means melt complex viscosity and X axis means angular frequency) and superposed on a melt complex viscosity-angular frequency curve at 190° C., and in this superposition, log-log curves of melt complex viscosity-angular frequency at respective temperatures (T) are allowed to shift at a magnification of a_{T} for angular frequency and a magnification of 1/a_{T} for melt complex viscosity for each curve. Correlation coefficient when the formula (I) is calculated by a least square method from values at four points of 130° C., 150° C., 170° C. and 190° C. is usually 0.99 or more.

Measurement of a melt complex viscosity-angular frequency curve is conducted usually under conditions of geometry: parallel plate, plate diameter: 25 mm, plate interval: 1.5 to 2 mm, strain: 5% and angular frequency: 0.1 to 100 rad/s, using a viscoelasticity measuring apparatus (e.g. Rheometrics Mechanical Spectrometer RMS-800 of Rheometrics). The measurement is conducted under a nitrogen atmosphere, and it is preferable to previously compound an antioxidant in a suitable amount (for example, 1000 wt-ppm) into a measurement sample.

The density of the ethylene-a-olefin-based copolymer as the component (i) is preferably 890 kg/m³ or more, more preferably 900 kg/m³ or more, further preferably 905 kg/m³ or more, from the standpoint of enhancement of rigidity of a pressure-foamed molding and secondary processability such as cut of a pressure-foamed molding. The density is preferably 930 kg m³ or less, more preferably 925 kg/m³ or less from the standpoint of enhancement of lightness of a pressure-foamed molding. The density is measured by an underwater substitution method described in JIS K7112-1980 after performing annealing described in JIS K6760-1995.

As the method of producing an ethylene-a-olefin-based copolymer as the component (i), there is mentioned a method of copolymerizing ethylene and an a-olefin having 3 to 20 carbon atoms in the presence of a catalyst obtained by contacting (A) a co-catalyst carrier described below, (B) a bridging type bisindenylzirconium complex, and (C) an organoaluminum compound.

The above-mentioned co-catalyst carrier (A) is a carrier obtained by contacting (a) diethylzinc, (b) a fluorinated phenol, (c) water, (d) silica and (e) trimethyldisilazane {((CH₃)₃Si)₂NH}.

The use amounts of the above-mentioned components (a), (b) and (c) are not particularly restricted, and when the molar ratio of use amounts of the components is component (a): component (b): component (c)=1:y:z, it is preferable that y an z satisfy the following formula:
|2−y−2z|=1,
wherein y in the above-mentioned formula is a number of preferably 0.01 to 1.99, more preferably 0.10 to 1.80, further preferably 0.20 to 1.50, most preferably 0.30 to 1.00.

The amount of the component (d) used based on the component (a) is such an amount that the molar number of a zinc atom contained in particles obtained by contact of the component (a) and the component (d) is preferably 0.1 mmol or more, more preferably 0.5 to 20 mmol per g of the particle. The amount of the component (e) used based on the component (d) is preferably 0.1 mmol or more, more preferably 0.5 to 20 mmol per g of the component (d).

The bridging type bisindenylzirconium complex (B) is preferably raceme-ethylenebis(1-indenyl)zirconium dichloride or raceme-ethylenebis(1-indenyl)zirconium diphenoxide.

The organoaluminum compound (C) is preferably triisobutylaluminum or tri-n-octylaluminum.

The use amount of the bridging type bisindenylzirconium complex (B) is preferably 5×10⁻⁶ to 5×10⁻⁴ mol per g of the co-catalyst carrier (A). The use amount of the organoaluminum compound (C) is preferably such an amount that the quantity of an aluminum atom in the organoaluminum compound (C) is 1 to 2000 mol per mol of a zirconium atom in the bridge type bisindenylzirconium complex (B).

The polymerization method is preferably a continuous polymerization method including formation of particles of an ethylene-a-olefin-based copolymer, and for example, continuous gas phase polymerization, continuous slurry polymerization and continuous bulk polymerization are mentioned, and preferable is continuous gas phase polymerization. The gas phase polymerization apparatus is usually an apparatus having a fluidized-bed type reaction vessel, and preferably, is an apparatus having a fluidized-bed type reaction vessel having an enlarged portion. A stirring blade may also be equipped in the reaction vessel.

As a method of feeding components of a metallocene-based olefin polymerization catalyst used for production of an ethylene-a-olefin-based copolymer as the component (i) to a reaction vessel, a method of feeding components under a moisture-free condition using an inert gas such as nitrogen or argon, hydrogen, ethylene or the like, and a method of dissolving or diluting components in a solvent and feeding the components in the form of solution or slurry, are usually used. Components of a catalyst may be fed separately, or any components may be previously contacted in any order and fed.

It is preferable to carry out preliminary polymerization before performing main polymerization, and to use preliminary polymerization catalyst components preliminarily polymerized as catalyst components or catalyst for the main polymerization.

The polymerization temperature is usually lower than a temperature at which an ethylene-a-olefin-based copolymer melts, and is preferably 0 to 150° C., more preferably 30 to 100° C.

For the purpose of regulating melt flowability of a copolymer, hydrogen may be added as a molecular weight regulator. An inert gas may be allowed to coexist in a mixed gas.

The ethylene-unsaturated ester-based copolymer as the component (ii) is a copolymer containing a monomer unit based on at least one unsaturated ester selected from vinyl carboxylates and alkyl esters of unsaturated carboxylic acids and a monomer unit based on ethylene. The vinyl carboxylates include vinyl acetate, vinyl propionate and the like, and the alkyl esters of unsaturated carboxylic acids include alkyl acrylates such as methyl acrylate, ethyl acrylate, n-propyl acrylate, isopropyl acrylate, n-butyl acrylate, t-butyl acrylate and isobutyl acrylate, alkyl methacrylates such as methyl methacrylate, ethyl methacrylate, n-propyl methacrylate, isopropyl methacrylate, n-butyl methacrylate, t-butyl methacrylate and isobutyl methacrylate.

As the ethylene-unsaturated ester-based copolymer as the component (ii), an ethylene-vinyl acetate copolymer, ethylene-methyl methacrylate copolymer, ethylene-methyl acrylate copolymer and ethylene-ethyl acrylate copolymer are preferably used.

The melt flow rate (MFR) of the ethylene-unsaturated ester-based copolymer as the component (ii) is usually in the range of 0.1 to 1000 g/10 minutes, and can be appropriately selected depending on the object. From the standpoint of enhancement of the strength of the resulting pressure-foamed molding, the MFR is preferably 100 g/10 minutes or less, more preferably 50 g/10 minutes or less, further preferably 20 g/10 minutes or less, most preferably 10 g/10 minutes or less. From the standpoint of enhancement of impact resilience, the MFR is preferably 20 g/10 minutes or less, more preferably 5 g/10 minutes or less, further preferably 4 g/10 minutes or less, and may be appropriately selected depending on the object.

From the standpoint of enhancement of the interlaminar adhesion of the resulting pressure-foamed molding, the MFR is preferably 0.2 g/10 minutes or more, more preferably 0.7 g/10 minutes or more. Further, in the case of obtaining a foamed molding of high foaming magnification, the MFR is preferably 4 g/10 minutes or more, more preferably 5 g/10 minutes or more, further preferably 6 g/10 minutes or more.

For obtaining a pressure-foamed molding having high foamed body strength and high foaming magnification, the MFR of an ethylene-unsaturated ester-based copolymer as the component (ii) is preferably in the range of 4 to 100 g/10 minutes.

For obtaining a pressurized foaming molded body having high foamed body strength and high impact resilience, the MFR is preferably in the range of 0.2 to 20 g/10 minutes. Therefore, the MFR may be appropriately selected from the above-mentioned range depending on the object. The MFR is a value measured by an A method under conditions of a temperature of 190° C. and a load of 21.18 N according to JIS K7210-1995.

In the ethylene-unsaturated ester-based copolymer as the component (ii), the total content of a monomer unit based on a vinyl carboxylate and a monomer unit based on an alkyl ester of unsaturated carboxylic acid is usually 2 to 50 wt %, preferably 5 to 45 wt % based on the total monomer unit content in the copolymer of 100 wt %. From the standpoint of enhancement of interlaminar adhesion, the content is preferably 5 wt % or more, more preferably 10 wt % or more, further preferably 15 wt % or more. When the content is over 50 wt %, the strength of a pressure-foamed molding may lower. The content is more preferably 40 wt % or less, further preferably 35 wt % or less. The content is measured by known methods. For example, the content of a monomer unit based on vinyl acetate is measured according to JIS K6730-1995.

The ethylene-unsaturated ester-based copolymer as the component (ii) is produced by a known polymerization method using a known olefin polymerization catalyst. For example, a bulk or solution polymerization method using a radical initiator, or the like is mentioned.

The resin composition of the present invention is a resin composition containing the component (i) and the component (ii), the content of the component (i) is 99 to 30 wt % and the content of the component (ii) is 1 to 70 wt % based on the total amount of the component (i) and the component (ii) of 100 wt %. When the content of the component (i) is less than 30 wt %, balance between lightness and rigidity of a pressure-foamed molding may lower. The content of the component (i) is preferably 40 wt % or more, more preferably 50 wt % or more, further preferably 60 wt % or more, most preferably 70 wt % or more. On the other hand, when the content of the component (i) is over 99 wt %, the interlaminar adhesion of a laminate may lower. Preferably, the content of the component (i) is 98 wt % or less, more preferably, the content of the component (i) is 95 wt % or less and the content of the component (ii) is 5 wt % or more, and further preferably, the content of the component (i) is 90 wt % or less. From the standpoint of enhancement of the impact resilience of a pressure-foamed molding, the content of the component (i) is preferably 70 wt % or less, more preferably 65 wt % or less.

In the resin composition of the present invention, the total content of a monomer unit based on a vinyl carboxylate and a monomer unit based on alkyl esters of unsaturated carboxylic acids in the component (ii) is preferably 1 to 15 wt % from the standpoint of enhancement of the interlaminar adhesion of a laminate, more preferably 10 wt % or less from the standpoint of further enhancement of the strength of a pressure-foamed molding, and more preferably 2 wt % or more from the standpoint of further enhancement of the interlaminar adhesion of a laminate, based on the total amount of the component (i) and the component (ii) of 100 wt %.

Further, from the standpoint of enhancement of the interlaminar adhesion of the resulting pressure-foamed molding, the compounding amount of the component (ii) when an MFR of the component (ii) to be used is small is preferably higher as compared with the compounding amount of the component (ii) when the MFR of the component (ii) is large. Namely, it is preferable that the MFR of the component (ii) and the content of the component (ii) in a resin composition (wherein, the total amount of the component (i) and the component (ii) is 100 wt %) satisfy the following formula (1), it is more preferable to satisfy the following formula (2).
log (M)=−0.02×W+0.48 (1)
log (M)=−0.02×W+0.85 (2)
M: MFR of component (ii) (unit: g/10 minutes)
W: content of component (ii) (unit: wt %)

A preferable resin composition for giving a pressure-foamed molding particularly having light weight, high strength and high forming magnification and for obtaining a laminate of excellent interlaminar adhesion in the present invention is described below.

A resin composition comprising the following components (i) and (ii) wherein the content of the component (i) is 98 to 50 wt % and the content of the component (ii) is 2 to 50 wt % based on the total amount of the components (i) and (ii) of 100 wt %:

(i) an ethylene-a-olefin-based copolymer comprising a monomer unit based on ethylene and a monomer unit based on an a-olefin having 3 to 20 carbon atoms wherein the melt flow rate is 0.01 to 5 g/10 minutes and the activation energy of flow is 40 kJ/mol or more,

(ii) an ethylene-unsaturated ester-based copolymer comprising a monomer unit based on at least one unsaturated ester selected from vinyl carboxylates and alkyl esters of unsaturated carboxylic acids and a monomer unit based on ethylene wherein the content of a monomer unit based on the unsaturated ester is 5 to 45 wt % and the melt flow rate is 4 to 100 g/10 minutes.

In the resin composition of the present invention, if necessary, various additives such as cross-linking auxiliaries, heat stabilizers, weathering agents, lubricants, antistatic agents, fillers and pigments (metal oxides such as zinc oxide, titanium oxide, calcium oxide, magnesium oxide and silicon oxide; carbonates such as magnesium carbonate and calcium carbonate; fiber substances such as pulp) may be compounded and, if necessary, resin-rubber components such as a high pressure processed low density polyethylene, high density polyethylene, polypropylene and polybutene may be compounded.

The resin composition of the present invention is suitably used for production of a pressure-foamed molding. As the method of producing a pressure-foamed molding using this resin composition, known pressurized foaming molding methods are adopted. For example, there are a method in which the component (i), component (ii) and a foaming agent are melt-mixed by a mixing roll, kneader, extruder or the like at temperatures causing no decomposition of the foaming agent to obtain a composition which is filled in a mold by an injection molding machine or the like and foamed under pressurized (pressure keeping) and heated condition, then, cooled, and the resulting pressure-foamed molding is removed, a method in which the composition obtained by melt-mixing is placed in a mold and foamed by a pressure pressing machine or the like under pressurized (pressure keeping) and heated condition, then, cooled, and the resulting pressure-foamed molding is removed, and the like.

In production of a pressure-foamed molding, the pressure-foamed molding obtained by the above-mentioned method may be cut into a desired shape, a member obtained by cutting may be further shaped with heating, or subjected to buff processing.

As the foaming agent which can be used in the present invention, thermal decomposition type foaming agents having a decomposition temperature not lower than the melt temperature of the copolymer are mentioned. For example, there are mentioned azodicarbonamide, barium azodicarboxylate, azobisbutyronitrile, nitrodiguanidine, N,N-dinitrosopentamethylenetetramine, N,N′-dimethyl-N,N′-dinitrosoterephthalamide, P-toluenesulfonyl hydrazide, P,P′-oxybis(benzenesulfonyl hydrazide)azobisisobutyronitrile, P,P′-oxybisbenzenesulfonyl semicarbazide, 5-phenyltetrazole, trihydrazinotriazine, hidrazodicarbonamide and the like, and these are used singly or in combination of two or more.

Of them, azodicarbonamide or sodium hydrogen carbonate is preferable. The compounding ratio of the foaming agent is usually 1 to 50 parts by weight, preferably 1 to 15 parts by weight based on the total amount of the component (i) and the component (ii) of 100 parts by weight.

In the above-mentioned composition obtained by melt mixing, a foaming auxiliary may be compounded, if necessary. The foaming auxiliary includes compounds containing urea as the main component; metal oxides such as zinc oxide and lead oxide; higher fatty acids such as salicylic acid and stearic acid; metal compounds of the higher fatty acids, and the like. The use amount of the foaming auxiliary is preferably 0.1 to 30 wt %, more preferably 1 to 20 wt % based on the total amount of the foaming agent and foaming auxiliary of 100 wt %.

In the above-mentioned composition obtained by melt mixing, a cross-linking agent may be compounded if necessary, and the composition containing the compounded cross-linking agent may be cross-linked and foamed with heating to give a cross-linked pressure-foamed molding. As the cross-linking agent, organic peroxides having a decomposition temperature not lower than the flow initiation temperature of the copolymer are suitably used, and examples thereof include dicumyl peroxide, 1,1-di-tertiary butyl peroxy-3,3,5-trimethylcyclohexane, 2,5-dimethyl-2,5-di-tertiary butyl peroxyhexane, 2,5-dimethyl-2,5-di-tertiary butyl peroxyhexine, a,a-di-tertiary butyl peroxy isopropylbenzene, tertiary butyl peroxyketone, tertiary butyl peroxy benzoate and the like. When the pressure-foamed molding of the present invention is used for a sole or sole member, it is preferable that the pressure-foamed molding is a cross-linked pressure-foamed molding.

A pressure-foamed molding can be obtained by the above-mentioned method in the present invention, and the foaming magnification is not particularly restricted, and preferably about 3 to 16 times, more preferably 5 to 13 times.

The laminate of the present invention is a laminate obtained by laminating a foamed layer produced by pressurized foaming molding of a resin composition of the present invention and a layer made of a material other than ethylene-based resins.

As the material to be laminated in pressurized foaming molding, at least one of materials other than ethylene-based resins such as vinyl chloride resin materials, styrene-based copolymer rubber materials, olefin-based copolymer rubber materials (e.g. ethylene-based copolymer rubber materials, propylene-based copolymer rubber materials) and the like, and leather-cloth materials such as natural leather materials, artificial leather materials, cloth materials and the like is used.

As the method of producing a laminate of the present invention, there are mentioned, for example, a method in which a resin composition of the present invention is subjected to pressurized foaming molding to give a pressure-foamed molding which is molded by the above-mentioned method, then, this pressure-foamed molding and a molded body made of a non-ethylene-based resin material are laminated by heat lamination, chemical adhesive or the like, and other methods. As the chemical adhesive, known adhesives can be used. Of them, particularly, urethane-based chemical adhesives, chloroprene-based chemical adhesives and the like are preferable. In pasting with these chemical adhesives, a overcoating material called primer may be applied previously.

The pressure-foamed molding of the present invention is excellent in balance between lightness and rigidity. For example, the pressure-foamed molding of the present invention is excellent in lightness as compared with a pressure-foamed molding composed of a conventional ethylene-vinyl acetate copolymer having rigidity of the same extent, and is excellent in rigidity as compared with a pressure-foamed molding composed of a conventional ethylene-vinyl acetate copolymer having lightness of the same extent. The pressure-foamed molding of the present invention is excellent in impact resilience, and also excellent in strength in the above-mentioned preferable composition range. Therefore, the pressure-foamed molding of the present invention is suitably used, for example, for a sole or sole member. The pressure-foamed molding of the present invention is excellent also in adhesion with a non-ethylene-based resin material, therefore, the molded body is used in lamination with various material as described above. For example, the pressure-foamed molding of the present invention is suitably used as an upper bottom (mid sole). The above-mentioned upper bottom is used as a sole or sole member by lamination with a lower bottom (outer sole) made of a non-ethylene-based resin material. The laminate of the present invention is used in various applications such as construction materials such as heat insulators, cushioning materials and the like.

### EXAMPLES

The present invention will be illustrated in detail by the following examples and comparative examples.

[I] Physical Property Measuring Method

(1) Melt Flow Rate (MFR, unit: g/10 Minutes)

The MFR was measured by an A method under conditions of a temperature of 190° C. and a load of 21.18 N according to JIS K7210-1995.

(2) Density (Unit: kg/m³)

Annealing described in JIS K6760-1995 was carried out, then, density was measured by an underwater substitution method described in JIS K7112-1980.

(3) Activation Energy of Flow (Ea, Unit: kJ/mol)

Dynamic viscosity-angular frequency curves at 130° C., 150° C., 170° C. and 190° C. were respectively measured under the following measuring conditions using a viscoelasticity measuring apparatus (Rheometrics Mechanical Spectrometer RMS-800 of Rheometrics), next, activation energy (Ea) was calculated using a calculation software Rhios V.4.4.4 of Rheometrics from the resultant dynamic viscosity-angular velocity curves.

<Measuring Conditions>

Geometry: parallel plate

Plate diameter: 25 mm

Plate interval: 1.5 to 2 mm

Strain: 5%

Angular frequency: 0.1 to 100 rad/s

Measurement atmosphere: under nitrogen

(4) Vinyl Acetate Unit Amount (Unit: wt %)

This was measured according to JIS K6730-1995.

(5) Density of Foamed Molding (Unit: kg/m³)

This was measured according to ASTM-D297. When this value is smaller, lightness is more excellent.

(6) Hardness of Foamed Molding (Unit: None)

This was measured by a C method hardness tester according to ASTM-D2240. When this value is larger, rigidity is more excellent.

(7) Impact Resilience of Foamed Molding (Unit: %)

An iron sphere was allowed to fall freely from a height (L₀) of 15 cm above the surface of a secondary molding onto the surface of the secondary molding, and a height (L) of bounce of the iron sphere from the surface of the secondary molding was measured, and impact resilience (unit: %) was calculated according to the following formula. The impact resilience was judged as described below by the value of impact resilience.
Impact resilience=L/L₀×100

L: bounce height of an iron sphere from the surface of a secondary molding (unit: cm)

L₀: fallen height of an iron sphere (unit: cm)

[Judge]

◯: impact resilience is 40% or more

Δ: impact resilience is less than 40%

(8) Strength of Foamed Molding (Unit: kg/cm)

The tear strength of a foamed molding was measured according to ASTM-D642. Specifically, a foaming molded body was sliced at a thickness of 10 mm, then, punched in the form of No. 3 dumbbell to make a specimen. This specimen was pulled at a speed of 500 mm/minute, and the maximum load F (kg) in breaking of the specimen was divided by a thickness of the sample piece of 1 cm to obtain tear strength.

(9) Interlaminar Adhesiveness of Laminate

A specimen of longitudinal 10 cm×transversal 2 mm×thickness 1 cm was cut from a secondary molding so that the surface of the secondary molding constituted one surface of longitudinal 10 cm×lateral 2 mm of the specimen, and a primer (“GE-320A” manufactured by Great Eastern Resins Industrial Co., Taiwan) was applied on an end portion of 3 cm in the longitudinal direction on the surface of longitudinal 10 cm×transversal 2 mm, and dried at 60 for 5 minutes. Then, a mixed liquid of an adhesive (“GE-420” manufactured by the same company) and a hardener (“348” manufactured by the same company. 4 wt % of the adhesive) was applied, and a rubber sheet (obtained by applying a primer (“GE-310A” manufactured by Daito Jushi, Taiwan) and drying this, then, applying a mixed liquid of an adhesive (“GE-420” manufactured by the same company) and a hardener (“348” manufactured by the same company)) was pasted and pressure-bonded, and dried at 60° C. for 5 minutes, to obtain a laminate having a foamed layer and a rubber layer. The adhesion strength between the foamed layer and the rubber layer was measured by peeling the foamed layer and the rubber layer of the multi-laminate at a peeling speed of 50 mm/minute using a 180° peeling tester. The interlaminar adhesiveness was evaluated from adhesion strength based on the following judge criterion 1 or 2.

Judge Criterion 1

⊚: adhesion strength is 2.5 kg/cm width or more

◯: adhesion strength is 2 kg/cm width or more and less than 2.5 kg/cm width

X: adhesion strength is less than 2 kg/cm width

Judge Criterion 2

⊚: adhesion strength is 3 kg/cm width or more

◯: adhesion strength is 2 kg/cm width or more and less than 3 kg/cm width

X: adhesion strength is less than 2 kg/cm width

### Example 1

(1) Preparation of Co-Catalyst Carrier

A solid product (hereinafter, referred to as co-catalyst carrier (A)) was prepared in the same manner as for a component (A) in Examples 10 (1) and (2) of JP 2003-171415 A.

(2) Preliminary Polymerization

Into a previously nitrogen-purged autoclave of a content volume of 210 liter equipped with a stirrer was charged 0.7 kg of the above-mentioned co-catalyst carrier (A) and 80 liter of butane, then, the autoclave was heated up to 30° C. Further, ethylene was charged in a quantity of 0.21 MPa in terms of gas phase pressure in the autoclave, and after an atmosphere in the system was stabilized, 70 mmol of raceme-ethylenebis(1-indenyl)zirconium diphenoxide was added and polymerization was initiated. The temperature was raised up to 45° C. and preliminary polymerization was performed at 49° C. for a total time of 4 hours while feeding ethylene and hydrogen continuously. After completion of polymerization, ethylene, butane, hydrogen gas and the like were purged and the remaining solid was vacuum-dried at room temperature, to obtain a preliminary polymerization catalyst component in which 14 g of an ethylene homopolymer had been preliminary polymerized per g of the above-mentioned co-catalyst carrier (A).

(3) Continuous Gas Phase Polymerization

Using the above-mentioned preliminary polymerization catalyst component, copolymerization of ethylene and 1-hexene was performed in a continuous mode fluidized bed gas phase polymerization apparatus. The polymerization conditions included a temperature of 75° C., a total pressure of 2 MPa, a molar ratio of hydrogen to ethylene of 0.31% and a molar ratio of 1-hexene to ethylene of 1.2%, and during the polymerization, ethylene, 1-hexene and hydrogen were fed continuously for maintaining the gas composition constant. Further, the above-mentioned preliminary polymerization catalyst component and triisobutylaluminum were continuously fed at a constant proportion so that the average polymerization time was 4 hours while maintaining the total powder weight in the fluidized bet at 80 kg. By polymerization, a powder of an ethylene-1-hexene copolymer (hereinafter, referred to as PE(1)) was obtained at a production efficiency of 22 kg/hr.

(4) Granulation of ethylene-1-hexene Copolymer Powder

The powder of PE(1) obtained above was granulated using LCM50 extruder manufactured by Kobe Steel, Ltd. under conditions of a feeding speed of 50 kg/hr, a screw revolution of 450 rpm, a gate opening of 50%, a suction pressure of 0.1 MPa and a resin temperature of 200 to 215° C., to obtain a pellet of PE(1). PE(1) had an MFR of 0.5 g/10 minutes, a density of 912 kg/m³ and an activation energy for flow of 72.9 kJ/mol.

(5) Pressurized-Foaming Molding

60 parts by weight of PE(1) and 40 parts by weight of an ethylene-vinyl acetate copolymer (manufactured by Sumitomo Chemical Co., Ltd., EVATATE K2010 [MFR=3 g/10 minutes, density=940 kg/m³, vinyl acetate unit amount=25 wt %], hereinafter, referred to as EVA(1)) were melt kneaded using a single screw kneader under conditions of a temperature of 150° C. and a screw revolution of 80 rpm to obtain a resin composition. Next, 100 parts by weight of the resin composition, 10 parts by weight of heavy calcium carbonate, 0.5 parts by weight of stearic acid, 1.5 parts by weight of zinc oxide, 3.5 parts by weight of a chemical foaming agent and 1.0 part by weight of dicumyl peroxide were kneaded using a roll kneader under conditions of a roll temperature of 120° C. and a kneading time of 5 minutes, to obtain a resin composition. The resin composition was filled in a mold of 22.8 cm×15 cm×1.2 cm and pressure-foamed under conditions of a temperature of 160° C., a time of 11 minutes and a pressure of 150 kg/cm², to obtain a primary foamed molding. Then, the resultant primary foamed molding was sliced at a thickness of 1.0 cm and filled in a mold of 26 cm×18 cm×1.0 cm and hot-pressed for 210 seconds under conditions of a temperature of 150° C. and a pressure of 150 kg/cm², then, cooled for 600 seconds to obtain a secondary foamed molding. Evaluation results of the physical properties of the resultant secondary foamed molding are shown in Table 1. Further, a laminate was produced in the method described in (9) Interlaminar adhesiveness of laminate, and interlaminar adhesiveness thereof was measured. The evaluation results are shown in Table 1.

### Example 2

(1) Preparation of Co-Catalyst Carrier

A solid product (hereinafter, referred to as co-catalyst carrier (A)) was prepared in the same manner as for component

(A) in Examples 10 (1) and (2) of JP 2003-171415 A.

(2) Preliminary Polymerization

Into a previously nitrogen-purged autoclave of a content volume of 210 liter equipped with a stirrer was charged 0.68 kg of the above-mentioned co-catalyst carrier (A), 80 liter of butane, 0.02 kg of 1-butene and, hydrogen in an amount of 3 liter under normal temperature and normal pressure, then, the autoclave was heated up to 30° C. Further, ethylene was charged in a quantity of 0.03 MPa in terms of gas phase pressure in the autoclave, and after an atmosphere in the system was stabilized, 216 mmol of triisobutylaluminum and 70 mmol of raceme-ethylenebis(1-indenyl)zirconium diphenoxide were added and polymerization was initiated. The temperature was raised up to 50° C. and preliminary polymerization was performed at 50° C. for a total time of 4 hours while feeding ethylene and hydrogen continuously. After completion of polymerization, ethylene, butane, hydrogen gas and the like were purged and the remaining solid was vacuum-dried at room temperature, to obtain a preliminary polymerized catalyst component in which 14 g of an ethylene-1-butene copolymer had been preliminary polymerized per g of the above-mentioned co-catalyst carrier (A).

(3) Continuous Gas Phase Polymerization

Using the above-mentioned preliminary polymerization catalyst component, copolymerization of ethylene and 1-hexene was performed in a continuous mode fluidized bed gas phase polymerization apparatus. The polymerization conditions included a temperature of 75° C., a total pressure of 2 MPa, a molar ratio of hydrogen to ethylene of 0.77% and a molar ratio of 1-hexene to ethylene of 1.98%, and during the polymerization, ethylene, 1-hexene and hydrogen were fed continuously for maintaining the gas composition constant. Further, the above-mentioned preliminary polymerization catalyst component and triisobutylaluminum were continuously fed at a constant proportion so that the average polymerization time was 4 hours while maintaining the total powder weight in the fluidized bed at 80 kg. By polymerization, a powder of an ethylene-1-hexene copolymer (hereinafter, referred to as PE(1)) was obtained at a production efficiency of 22 kg/hr.

(4) Granulation of ethylene-1-hexene Copolymer Powder

The powder of PE(1) obtained above was granulated using LCM50 extruder manufactured by Kobe Steel, Ltd. under conditions of a feeding speed of 50 kg/hr, a screw revolution of 450 rpm, a gate opening of 50%, a suction pressure of 0.1 MPa and a resin temperature of 200 to 215° C., to obtain a pellet of PE(1). PE(1) had an of 0.5 g/10 minutes, a density of 912 kg/m³ and an activation energy of flow of 73 kJ/mol.

(5) Pressurized-Foaming Molding

80 parts by weight of PE(1) and 20 parts by weight of an ethylene-vinyl acetate copolymer (manufactured by Sumitomo Chemical Co., Ltd., SUMITATE KA-31 [MFR=7 g/10 minutes, density=940 kg/m³, vinyl acetate unit amount=28 wt %], hereinafter, referred to as EVA(1)) were melt-blended using a single screw kneader under conditions of a temperature of 150° C. and a screw revolution of 80 rpm to obtain a resin composition. Next, 100 parts by weight of the resin composition, 10 parts by weight of heavy calcium carbonate, 0.5 parts by weight of stearic acid, 1.5 parts by weight of zinc oxide, 3.5 parts by weight of a chemical foaming agent and 1.0 part by weight of dicumyl peroxide were kneaded using a roll kneader under conditions of a roll temperature of 120° C. and a kneading time of 5 minutes, to obtain a resin composition. The resin composition was filled in a mold of 22.8 cm×15 cm×1.2 cm and pressure-foamed under conditions of a temperature of 160° C., a time of 11 minutes and a pressure of 150 kg/cm², to obtain a primary foamed molding. Then, the resultant primary foamed molding was sliced at a thickness of 1.0 cm and filled in a mold of 26 cm×18 cm×1.0 cm and heat-pressed for 210 seconds under conditions of a temperature of 150° C. and a pressure of 150 kg/cm², then, cooled for 600 seconds to obtain a secondary foamed molding. Evaluation results of the physical properties of the resultant secondary molded body are shown in Table 1. Further, a laminate was produced in the method described in (9) Interlaminar adhesion of laminate, and interlaminar adhesiveness thereof was measured. The evaluation results are shown in Table 1.

### Example 3

80 parts by weight of PE(1) and 20 parts by weight of an ethylene-vinyl acetate copolymer (manufactured by The Polyolefin Company, COSMOTHENE H2181 [MFR=2 g/10 minutes, density=940 kg/m³, vinyl acetate unit amount=18 wt %], hereinafter, referred to as EVA(2)) were melt kneaded using a single screw kneader under conditions of a temperature of 150° C. and a screw revolution of 80 rpm to obtain a resin composition. Next, 100 parts by weight of the resin composition, 10 parts by weight of heavy calcium carbonate, 0.5 parts by weight of stearic acid, 1.5 parts by weight of zinc oxide, 3.5 parts by weight of chemical foaming agent and 1.0 part by weight of dicumyl peroxide were kneaded using a roll kneader under conditions of a roll temperature of 120° C. and a kneading time of 5 minutes, to obtain a resin composition. The resin composition was filled in a mold of 22.8 cm×15 cm×1.2 cm and pressure-foamed under conditions of a temperature of 160° C., a time of 11 minutes and a pressure of 150 kg/cm², to obtain a primary foamed molding. Then, the resultant primary foamed molding was sliced at a thickness of 1.0 cm and filled in a mold of 26 cm×18 cm×1.0 cm and heat-pressed for 210 seconds under conditions of a temperature of 150° C. and a pressure of 150 kg/cm², then, cooled for 600 seconds to obtain a secondary molding. Evaluation results of the physical properties of the resultant secondary molded body are shown in Table 1. A laminate was produced in the method described in (9) Interlaminar adhesiveness of laminate, and interlaminar adhesiveness thereof was measured. The evaluation results are shown in Table 1.

### Comparative Example 1

100 parts by weight of an ethylene-vinyl acetate copolymer (manufactured by The Polyolefin Company, COSMOTHENE H2181 [MFR=2 g/10 minutes, density=940 kg/m³, vinyl acetate unit amount=18 wt %], hereinafter, referred to as EVA(3)), 10 parts by weight of heavy calcium carbonate, 0.5 parts by weight of stearic acid, 1.5 parts by weight of zinc oxide, 3.0 parts by weight of chemical foaming agent and 0.7 parts by weight of dicumyl peroxide were kneaded using a roll kneader under conditions of a roll temperature of 120° C. and a kneading time of 5 minutes, to obtain a resin composition. The resin composition was filled in a mold of 22.8 cm×15 cm×1.2 cm and pressure-foamed under conditions of a temperature of 160° C., a time of 11 minutes and a pressure of 150 kg/cm², to obtain a primary foamed molding. Then, the resultant primary foamed molding was sliced at a thickness of 1.0 cm and filled in a mold of 26 cm×18 cm×1.0 cm and heat-pressed for 210 seconds under conditions of a temperature of 150° C. and a pressure of 150 kg/cm², then, cooled for 600 seconds to obtain a secondary molding. Evaluation results of the physical properties of the resultant secondary molding are shown in Table 1. A laminate was produced in the method described in (9) Interlaminar adhesiveness of laminate, and interlaminar adhesiveness thereof was measured. The evaluation results are shown in Table 1.

TABLE 1

| | | Exam- | | | Comparative |
|---|---|---|---|---|---|
| Item | Unit | ple 1 | Example 2 | Example 3 | Example 1 |
| Ethylene-a-ole | | PE(1) | PE(2) | PE(1) | — |
| fin copolymer | | | | | |
| Content | wt % | 60 | 80 | 80 | — |
| MFR | g/10 | 0.5 | 0.5 | 0.5 | — |
| | minutes | | | | |
| Density | kg/m³ | 912 | 912 | 912 | — |
| Activation | KJ/mol | 73 | 73 | 73 | — |
| energy of flow | | | | | |
| Ethylene-vinyl | | EVA(1) | EVA(2) | EVA(3) | EVA(3) |
| acetate | | | | | |
| copolymer | | | | | |
| Content | wt % | 40 | 20 | 20 | 100 |
| MFR | g/10 | 3 | 7 | 2 | 2 |
| | minutes | | | | |
| Density | kg/m³ | 940 | 940 | 940 | 940 |

Foamed molding

| | | | | | |
|---|---|---|---|---|---|
| Density | kg/m³ | 193 | 190 | 160 | 211 |
| Hardness | — | 55 | 55 | 55 | 55 |
| Strength | kg/cm | 16.3 | 18.9 | — | 14.2 |
| Interlaminar | — | ⊚*¹ | ⊚*¹ | ◯*¹ | ⊚*¹ |
| adhesiveness | | ◯*² | ⊚*² | ◯*² | ◯*² |
| of laminate | | | | | |
| Impact | — | ◯ | ◯ | Δ | ◯ |
| resilience | | | | | |

Note:
*¹evaluation criterion 1
*²evaluation criterion 2

1. A resin composition comprising the following components (i) and (ii) wherein a content of the component (i) is 99 to 30 wt % and a content of the component (ii) is 1 to 70 wt % based on the total amount of the components (i) and (ii) of 100 wt %:
(i) an ethylene-α-olefin-based copolymer comprising a monomer unit based on ethylene and a monomer unit based on an α-olefin having 3 to 20 carbon atoms wherein the melt flow rate is 0.01 to 5 g/10 minutes and the activation energy for flow is 30 kJ/mol or more,
(ii) an ethylene-unsaturated ester-based copolymer comprising a monomer unit based on at least one unsaturated ester selected from vinyl carboxylates and alkyl esters of unsaturated carboxylic acids and a monomer unit based on ethylene.

2. The resin composition according to claim 1, wherein the activation energy for flow of the ethylene-α-olefin-based copolymer (i) is 40 kJ/mol or more.

3. The resin composition according to claim 1, wherein the content of a monomer unit based on the unsaturated ester in the component (ii) is 5 to 45 wt %.

4. The resin composition according to claim 1, comprising the following components (i) and (ii) wherein the content of the component (i) is 98 to 50 wt % and the content of the component (ii) is 2 to 50 wt % based on the total amount of the components (i) and (ii) of 100 wt %:
(i) an ethylene-α-olefin-based copolymer comprising a monomer unit based on ethylene and a monomer unit based on an α-olefin having 3 to 20 carbon atoms wherein the melt flow rate is 0.01 to 5 g/10 minutes and the activation energy for flow is 40 kJ/mol or more,
(ii) an ethylene-unsaturated ester-based copolymer comprising a monomer unit based on at least one unsaturated ester selected from vinyl carboxylates and alkyl esters of unsaturated carboxylic acids and a monomer unit based on ethylene wherein the content of a monomer unit based on the unsaturated ester is 5 to 45 wt % and the melt flow rate is 4 to 100 g/10 minutes.

5. A pressure-foamed molding obtained by pressurized-foaming molding of the resin composition according to claim 1.

6. A pressure-foamed molding obtained by pressurized-foaming molding of the resin composition according to claim 4.

7. A sole comprising the pressure-foamed molding according to claim 5.

8. A laminate obtained by laminating a foamed layer of the pressure-foamed molding according to claim 5 and a layer composed of a material other than an ethylene-based resin.

9. A sole comprising the laminate according to claim 8.

10. A laminate obtained by laminating a foamed layer of the pressure-foamed molding according to claim 6 and a layer composed of a material other than an ethylene-based resin.

11. The laminate according to claim 8, wherein the layer composed of a material other than an ethylene-based resin is a layer containing at least one material selected from the group consisting of vinyl chloride resin materials, styrene-based copolymer rubber materials, olefin-based copolymer rubber materials, natural leather materials, artificial leather materials and cloth materials.

12. The laminate according to claim 10, wherein the layer composed of a material other than an ethylene-based resin is a layer containing at least one material selected from the group consisting of vinyl chloride resin materials, styrene-based copolymer rubber materials, olefin-based copolymer rubber materials, natural leather materials, artificial leather materials and cloth materials.
